(19) United States
(12) Patent Application Publication
(10) Pub. No.: US 2007/0277064 A1
(43) Pub. Date: Nov. 29, 2007

(54) RECONFIGURABLE CONVOLUTIONAL INTERLEAVER/DEINTERLEAVER USING MINIMUM AMOUNT OF MEMORY AND AN ADDRESS GENERATOR

(75) Inventor: Yi-Fu Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/381,162

(22) Filed: May 2, 2006

(51) Int. Cl. G06F 11/00

(52) U.S. Cl. 714/701

(57) ABSTRACT

An address generator applied to a convolutional interleaver/deinterleaver generates an address for reading/storing data symbols from/to a memory. The memory conceptually divides into branches, segments and cells. The address generator maintains cyclic counters including a cyclic branch counter, a cyclic cell counter, N cyclic segment counters for counting the branch, segment and cell for generating the address. The address generator also comprising a processor generates an address according to the values of the cyclic branch counter, the cyclic cell counter, and N segment counters for indicating a memory cell for reading and storing data symbols.

### BACKGROUND

The invention relates to interleavers/deineterleavers for communication systems, and more particularly, to convolutional interleavers/deinterleavers using minimum amount of memory.

One technique for managing errors in transmission uses error correction and detection codes, such as the Reed-Solomon (RS) encoding and decoding techniques. Reed-Solomon encoded data can be viewed as a sequence of error protected symbols. Errors within the error protected symbols can be detected, and most can be corrected.

Reed-Solomon coding is good at detecting and correcting isolated errors that occur in a communication channel, however, burst errors of long duration make Reed-Solomon decoding insufficient. Burst errors often occur because of disturbances in the transmission path, e.g. channel fading effect. Convolutional interleaving and deinterleaving techniques on either end of the transmission path are used to interleave the Reed-Solomon symbols so that the effects of burst errors are distributed when the Reed-Solomon symbols are deinterleaved, and do not overwhelm the error correcting and detecting codes.

FIG. 1 shows a block diagram of a communication system, including a Reed-Solomon encoder 102 encoding a stream of baseband signal S_{B} into Reed-Solomon coded data, a convolutional interleaver 104 permuting the Reed-Solomon coded data to form a transmit signal. Burst errors occur in the transmitted signal while transmitting on channel 106. A convolutional deinterleaver 108 receives the transmitted signal and de-permutes the data carried by the transmitted signal so that the burst errors scatter, thereby improving the error correction effect of the Reed-Solomon decoder 110.

FIGS. 2 and 3 illustrate convolutional interleaving and deinterleaving, respectively. In convolutional interleaving, as shown in FIG. 2, the interleaver comprises N branches, shown as Branch 0 through Branch N−1 in the FIG. 2. The first branch, Branch 0, is a transmission line. The second branch, Branch 1, has a first-in first-out (FIFO) buffer having M memory cells. Each memory cell is used to store one data symbol. Typically, the bit number of each memory cell equals to the bit number of the input symbol. M is a pre-determined integer. The third branch, Branch 2, is another FIFO buffer having 2*M memory cells, and so on until the last branch, Branch N−1, which is a FIFO buffer having (N−1)*M memory cells. The interleaver receives an input data symbol, which usually have been error-protected. The input data symbol has a fixed number of bits. The input data symbol stores to the left side of each branch buffer as shown in the FIG. 2, from Branch 0 to Branch N−1. For example, the first input symbol is stored to Branch 0, the second input symbol is stored to Branch 1, and so on. The most previously stored data symbol is read from the right side of each branch buffer as shown in the FIG. 2, from Branch 0 to Branch N−1. Thus, the first output symbol is read from Branch 0, and the second output symbol is read from Branch 1. The third output symbol is read from Branch 2, and so on until the N^{th} output symbol is read from the output port of the Branch N−1.

For example, consider an interleaver of N=3 and M=1, data stored in all branch buffers are initialized to zero, and the input symbols are 1, 2, 3, 4, 5, 6, 7, 8 and 9. The first input symbol, 1, turns to Branch 0, which directly by passes to the output of Branch 0 to form the first output symbol of the interleaver. The second input symbol, 2, is stored to the left of the Branch 1 buffer, and a previously stored symbol is read from the right of the Branch 1 buffer, i.e. zero, to form the second output symbol. The third input symbol, 3, is stored to the left of the Branch 2 buffer, and a most previously stored symbol is read from the right of the Branch 2 buffer, i.e. zero, to form the third output symbol. Then, the fourth input symbol 4 turns to Branch 0, which directly by passes to the output of to form the fourth output symbol of the interleaver. The fifth input symbol 5 turns to the Branch 1. The fifth input symbol 5 stores to the left of the Branch 1 buffer, the previously stored symbol is read from the right of Branch 1 buffer, the second input symbol 2, to form the fifth output symbol. Then, the sixth input symbol 6 turns to Branch 2. The sixth input symbol 6 stores to the left of the Branch 2 buffer, the most previously stored symbol is read from the right of the Branch 2 buffer, which is zero, to form the sixth output symbol. Then, the seventh input symbol 7 turns back to Branch 0 again. Similarly, the seventh input symbol 7 directly by passes to the output of Branch 0 to form the seventh output symbol of the interleaver. Now the eighth input symbol 8 turns to Branch 1. The eighth input symbol 8 stores to the left of the Branch 1 buffer, the previously stored symbol is read from the right of the Branch 1 buffer, which is the fifth input symbol 5, to form the eighth output symbol. Then, the ninth input symbol 9 turns to Branch 2. The ninth input symbol 9 stores to the left of the Branch 2 buffer, the most previously stored symbol is read from the right of the Branch 2 buffer, which is the third input symbol 3, to form the ninth output symbol. Therefore, for the input symbols 1, 2, 3, 4, 5, 6, 7, 8 and 9, the output symbols of the interleaver are 1, 0, 0, 4, 2, 0, 7, 5, 3 . . .

FIG. 3 illustrates a convolutional deinterleaver corresponding to the interleaver. The deinterleaver at the receiver applies the inverse permutation to recover the transmitted symbols. Thus, the deinterleaver has a structure symmetrical to that of the interleaver. The first branch of the deinterleaver, Branch N−1, has (N−1)*M memory cells. The second branch, Branch N−2, has (N−2)*M memory cells, and so on. The last branch, Branch 0, is a transmission line. The deinterleaver receives the interleaved data at the input port, the left side as shown in the FIG. 3, and writes it into Branch N−1 to Branch 0 by turns.

For example, an de-interleaver of N=3, M=1, data stored in all buffers are initialized to zero, and the input sequence is 1, 0, 0, 4, 2, 0, 7, 5, 3, 10, 8, and 6, generated by the interleaver. The first input symbol, 1, stores to the left of the first branch buffer, Branch 2, and a previously stored symbol is read from the right of the Branch 1 buffer, i.e. zero, to form the first output symbol of the deinterleaver. The second input symbol, 0, stores to the left of the Branch 1 buffer and a most previously stored symbol is read from the right of the Branch 1 buffer, i.e. zero, to form the second output symbol. The third input symbol, 0, stores to Branch 0, and is directly by passed to the output of Branch 0. The fourth symbol, 4, stores to the left of the Branch 2 buffer, and a most previously stored symbol is read from the right of the Branch 2 buffer, i.e. zero, to form the fourth output symbol. Now the fifth input symbol, 2, turns to Branch 1, the previously stored symbol is read from the right of the Branch 1 buffer, which is the second input symbol 0, to form the fifth output symbol. The sixth input symbol, 0, is directly by passed Branch 0 to the output. Similarly, the seventh input symbol, 7, stores to the left of the Branch 2 buffer, the most previously stored symbol is read from the right of the Branch 2 buffer, which is the first input symbol, 1, to form the seventh output symbol. The eighth input symbol 5 turns to Branch 1. The eighth input symbol 5 stores to the left of the Branch 1 buffer, the previously stored symbol is read from the right of the Branch 1 buffer, which is the fifth input symbol 2, to form the eighth output symbol. Then, the ninth input symbol 3 is directly by passed to the output of Branch 0 to form the ninth output symbol of the deinterleaver, and so on. Finally, the otmput pattern is 0, 0, 0, 1, 2, 3, 4, 5, 6 . . .

This description interprets the case of M=1, i.e. one memory segment containing one memory cell, and one memory cell storing one data symbol. For the interleaver/deinterleaver with M larger than 1, a memory segment containing M memory cells respectively storing M data symbols. Thus, shifting a symbol M times represents shifting the symbol across M memory cells, that is, one memory segment.

Conceptually, the convolutional interleaver and deinterleaver of FIGS. 2 and 3 can be implemented as shift registers. However, an exact hardware implementation of this architecture is very inefficient in terms of circuit area.

Thus, it is desirable to provide an interleaver/deinterleaver architecture utilizing less space on integrated circuits. It would therefore be advantageous to provide an efficient address generator for a convolutional interleaver/deinterleaver implemented in random access memory (RAM), which enables a reduction of the amount of RAM.

### SUMMARY

Accordingly, convolutional interleaver/deinterleaver are provided. A (N, M) convolutional interleaver/deinterleaver comprises an input port, a storage device, an address generator, and an output port. The input port receives an input data symbol. The storage device comprises an address input, a data input/output port. The address generator generates an address for reading/storing a data symbol from/to the storage device of the convolutional interleaver/deinterleaver. The output port delivers an output symbol according to the data symbol reading from the storage device or the input data symbol bypassing from the input port. The storage device conceptually divides into branches, segments and cells. The address generator maintains cyclic counters including a cyclic branch counter, a cyclic cell counter, N cyclic segment counters for counting the branches, segments and cells for generating the address. The address generator also comprising a processor generates an address according to the values of the cyclic branch counter, the cyclic cell counter, and N segment counters for indicating a memory cell for reading and storing data symbols.

### BRIEF DESCRIPTION OF THE DRAWINGS

FIG. 1 is a block diagram of a communication system including an interleaver and a deinterleaver;

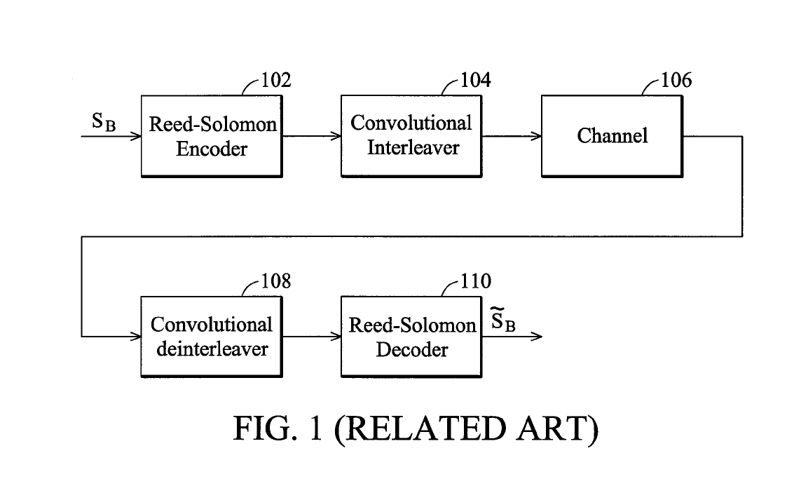

FIG. 2 illustrates the structure of a convolutional interleaver;

FIG. 3 illustrates the structure of a convolutional de-interleaver;

FIG. 4 is a block diagram of a convolutional de-interleaver according to an embodiment of the invention;

FIG. 5 shows the structure of an address generator according to an embodiment of the invention;

FIG. 6 shows address of the memory cells according to an embodiment of the invention;

FIG. 7 shows address of the memory cells according to one another embodiment of the invention; and

FIG. 8 shows address of the memory cells according to still another embodiment of the invention.

### DETAILED DESCRIPTION

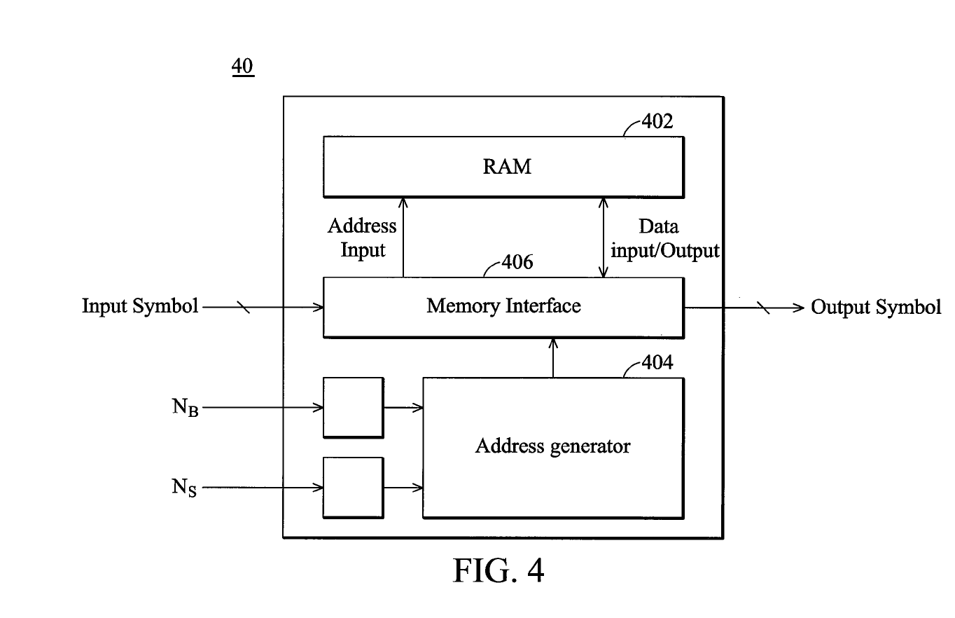

FIG. 4 shows a block diagram of a convolutional de-interleaver diagram according to an embodiment of the invention. The convolutional de-interleaver 40 comprises a RAM 402, an address generator 404, and a memory interface 406. The RAM 402 comprises an address input port, and a data input/output port. The address generator 404 generates an address indicating a location of storage in the RAM 402. The location of storage is for storing data at the data input port of the RAM also for reading out the stored data to the data output port. The memory interface 406 arbitrates whether should bypass or not an input symbol to the output port according to the generated address.

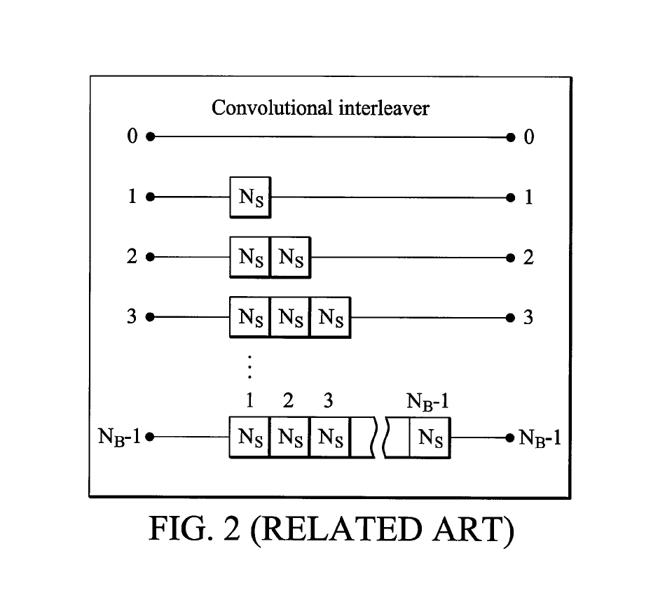

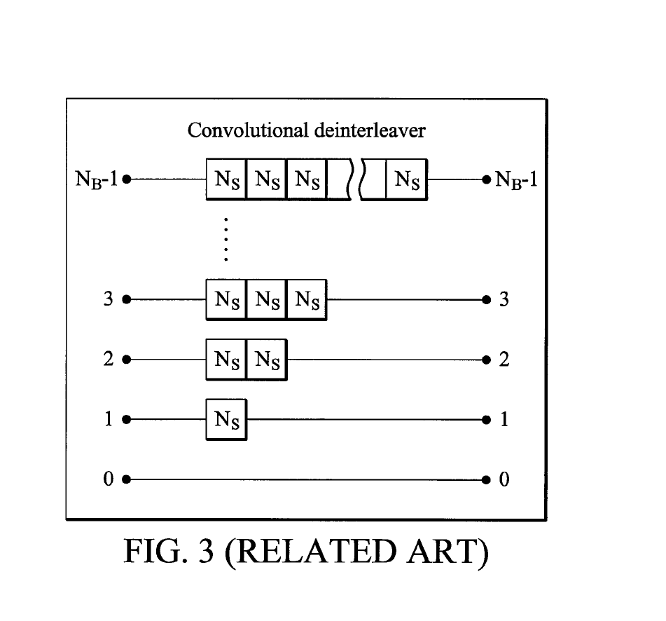

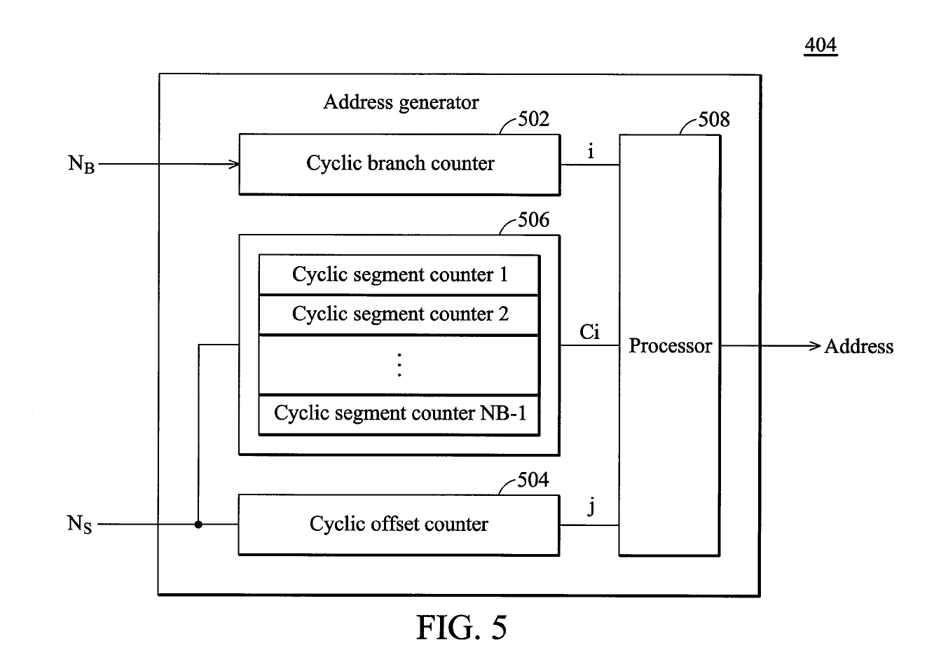

FIG. 5 illustrates the address generator 404 having a cyclic branch counter 502, a cyclic cell counter 504, N cyclic segment counters 506, and a processor 508. Recall the FIGS. 2 and 3, the FIFO buffer in each branch conceptually divides into multiple segments, wherein each segment containing M memory cells. The value of a cyclic counter ranges from a maximum to a minimum. The cyclic counter initializes as the minimum(or maximum) value, counts up(or down) to increase(decrease) the counter value till reaching the maximum(minimum) value, then returns back to the initial value to successively count up(down) again. The cyclic cell counter 504 indicates one cell within a memory segment. The value i of the cyclic branch counter 502 ranges from 0 to N−1, increases (or decreases) every time when a symbol is store to the RAM. The N cyclic segment counters respectively correspond to N memory branches, each of the N cyclic segment counters indicates one segment within the corresponding memory branch. The value j of the cyclic cell counter 504 ranges from 0 to M−1, increases (or decreases) every time when the cyclic branch counter 502 returns to the initial value. The values of the N cyclic segment counters are represented as C₁, . . . , Cₙ, . . . , C_{N-}1. Each Cᵢ corresponds to branch i, ranges from 0 to Uᵢ-1 where Uᵢ is the numbers of memory segments of the i^{th} branch, increases (or decreases) every time when the cyclic cell counter returns back to its initial value.

The memory interface 406 bypasses an input symbol to the output port as an output symbol when cyclic branch counter indicates a branch with Uᵢ=0. The processor 508 generates the address of the memory according to i, j, C₁ to C_{N-1}, and U₁ to U_{N-}1. In an embodiment of the invention, the processor 508 generates the address ADDR₁ according to formula 1:
ADDR₁=M*(Bᵢ+Cᵢ)+j (1)
where Bᵢ=(N−1)+(N−2)+. . . +(i+2)+(i+1), and Cᵢ is the value of i^{th} cyclic segment counter. Thus, the formula can be written in sigma form:

$${ADDR}_{1} = ( {C}_{i} + {\sum }_{n = i + 1}^{N - 1} {U}_{n} ) . M + j \cdot \qquad ( 1.1 )$$

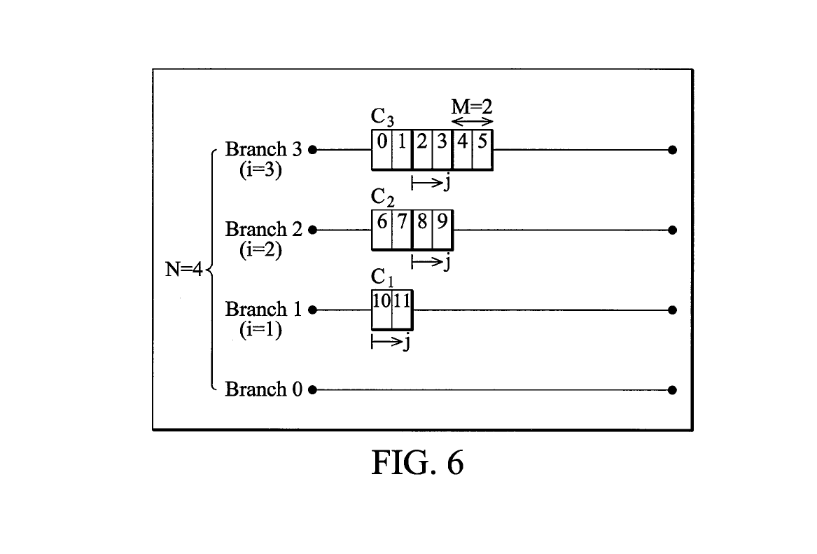

As one can see, the ADDR₁ addresses the memory cell in FIG. 4 from branch 3 to branch 0. FIG. 6 shows an exemplary embodiment for N=4 and M=2. According to the formula (1), each memory cell is addressed mainly in an order of branches, as cells/segments of a first branch then cells/segments of a second branch, from branch 3 to branch 0. While the input symbol is fed as a sequence of {s₁, s₂, . . . , s₁₂}, the ADDR1 are generated by formula 1 to indicate the address of the memory cell to store the corresponding input symbol (s₁,0), (S₂,6), (s₃,10), (s₅,1), (s₆,7), (s₇,11), (s₉,2), (s₁₀,8), (s₁₁,10). For symbol s₄, s₈ and s₁₂, the cyclic branch counter 502 counts to branch 0, the memory interface 406 shown in FIG. 4 bypasses an input symbol to the output port as an output symbol. For the cyclic branch counter 502 counts to branches other than branch 0, the memory interface 406 sends the input symbol and the address generated by the address generator 404 to the RAM for accordingly reading/storing the symbol from/to the RAM, then delivers the data read from the RAM as an output symbol. In FIG. 6, segment counter C, ranges from 0 to U₁-1, segment counter C₂ ranges from 0 to U₂-1, and segment counter C₃ ranges from 0 to U₃-1, where U₁=1, U₂=2, and U₃=3.

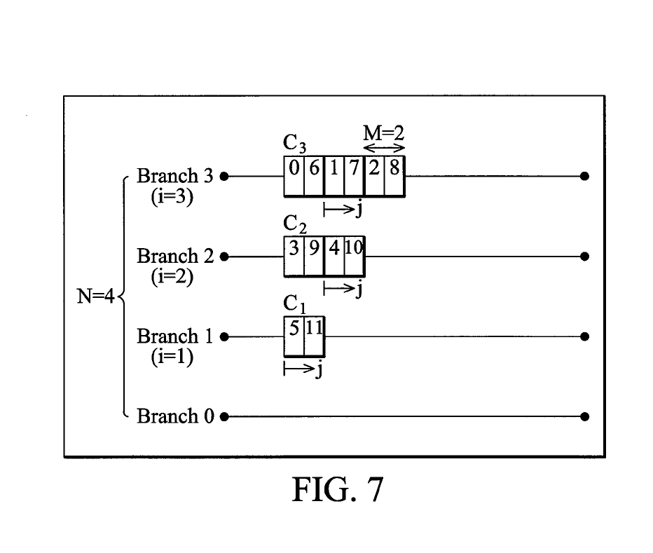

As shown in FIG. 7, the other exemplary embodiment for N=4 and M=2. The memory cells are addressed mainly in an order of cells, as a first cell of each segments/branches, then a second cell of each segments/branches, from branch3 to branch0. An ADDR₂ is generated by formula 2 to indicate the address of the memory cell to read/store the corresponding symbol:
ADDR₂=(Bᵢ+Cᵢ)+(j* Δ) (2)
wherein Bᵢ is as previously defined, and

$$Δ = {\sum }_{n = 0}^{N - 1} {U}_{n} = N * ( N - 1 ) / 2$$

is the number of memory cells occupied by cell 0 of each segments/branches. The formula 2 can be written in sigma form:

$${ADDR}_{2} = ( {C}_{i} + {\sum }_{n = i - 1}^{N - 1} {U}_{n} ) + j \cdot ( {\sum }_{n = 0}^{N - 1} {U}_{n} ) . \qquad ( 2.1 )$$

While the input symbol is fed as a sequence of {s₁, S₂, . . . , S₁₂}, according to the formula (2) the ADDR₂ are generated to indicate the address of the memory cell to store the corresponding input symbol (s₁,0), (s₂,3), (s₃,5), (s₅,6), (s₆,9), (s₇,11), (s₉,1), (s₁₀,4), (s₁₁,5). For symbols s₄, s₈ and s₁₂, the cyclic branch counter 502 counts to branch 0, the memory interface 406 shown in FIG. 4 bypasses an input symbol to the output port as an output symbol. For the cyclic branch counter 502 counts to branches other than branch 0, the memory interface 406 sends the input symbol and the address generated by the address generator 404 to the RAM for accordingly reading/storing the symbol from/to the RAM, then delivers the data symbol read from the RAM as an output symbol. In FIG. 7, segment counter C₁ ranges from 0 to U₁-1, segment counter C₂ ranges from 0 to U₂-1, and segment counter C₃ ranges from 0 to U₃-1, where U₁=1, U₂=2, and U₃=3.

In one embodiment of the invention, the address generator 404 comprises two registers storing M and N, respectively specifying the number of memory cells of a segment and the number of branches in the convolutional interleaving/de-interleaving. Programmable M and N provide an adaptive architecture for modern communication standards, which specifies a wide variety of values of N and M. For example, the digital cable standards of North American, ITU-T/J.83B, specify (N, M) being (128, 1), (64, 2), and (32, 4).

Since a de-interleaver performs the inverse operation of interleaver, structure of an interleaver is similar as FIG. 4, excepting the formula applied by the address generator.

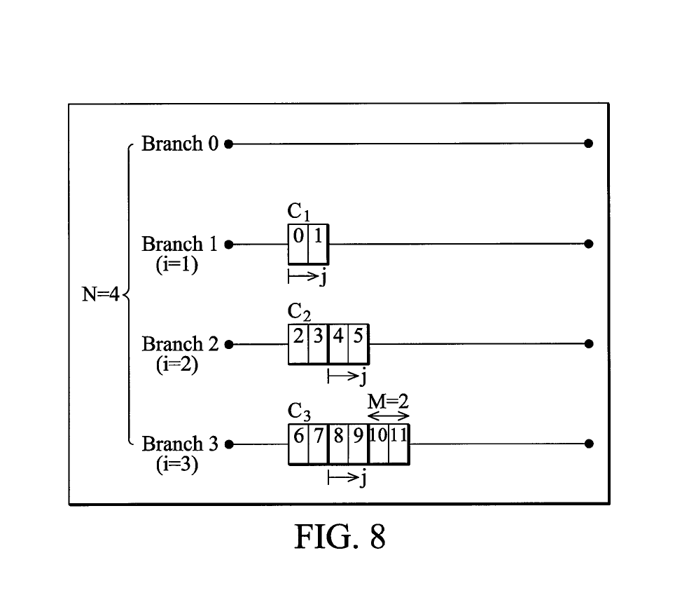

As shown in FIG. 8, one another embodiment of the invention, the ADDR₃ is generated by formula 3 to indicate one memory cell in the RAM to read and store the corresponding data symbol,
ADDR₃=M*(Aᵢ+Cᵢ)+j (3)
where Aᵢ=1+2+. . . +(i−2)+(i−1). Thus, formula 3 can be also written in sigma form:

$${ADDR}_{3} = M * ( {\sum }_{n = 0}^{i - 1} {U}_{n} + {C}_{i} ) + j , \qquad ( 3.1 )$$

Unlike formula (1), the formula (3) addresses the memory cell mainly in an order of branches, as cells/segments of a first branch then cells/segments of a second branch, from branch 0 to branch 3. The exemplary embodiment for M=2, N=4 is shown as FIG. 8. In FIG. 8, segment counter C₁ ranges from 0 to U₁-1, segment counter C₂ ranges from 0 to U₂-1, and segment counter C₃ ranges from 0 to U₃-1, where U₁=1, U₂=2, and U₃=3.

In one still another embodiment of the invention, the ADDR₄ is generated by the formula (4) to indicate the memory cell address to read/store the corresponding symbol,
ADDR₄=(Aᵢ+Cᵢ)+j* Δ (4)
where

$$Δ = ( {\sum }_{n = 0}^{N - 1} {U}_{n} ) = N * ( N - 1 ) / 2 ,$$

and Aᵢ is as previously defined. The formula 4 also can be written in sigma form:

$${ADDR}_{4} = ( {\sum }_{n = 0}^{i - 1} {U}_{ n} + {C}_{ i} ) + ( j \cdot {\sum }_{n = 0}^{N - 1} {U}_{n} ) , \qquad ( 4.1 )$$

ADDR₄ addresses the memory cell mainly in an order of cells, as a first cell in each segments/branches, then a second cell in each segments/branches, from branch0 to branch3.

Accordingly, the invention provides an architecture for a programmable convolutional interleaver/deinterleaver, suitable for implementation in an integrated circuit, and relying on single port memory. The architecture is suited to communication channel processors, which use the convolutional interleaving and deinterleaving to distribute error protected packets to minimize the impact of burst type errors in a communication channel.

Please note that a definition of interleaver and deinterleaver depends not on structures, but rather position of a communication system. More generally, a device for permuting transmitted symbols is an interleaver, and a device for rearrange the permuted symbol to its original order is a deinterleaver. Thus, the depiction of interleaver is not limited to an interleaver, in specially cases, the interleaver described above can be defined as deinterleaver, and vice versa.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An address generator applied to an interleaver/de-interleaver generating an address for reading/storing a data symbol from/to a memory, which the memory is conceptually divides into branches, segments and cells, the address generator comprising:
a cyclic branch counter generating counter value i, wherein the value i ranges from 0 to N−1 respectively indicating branch 0 to branch N−1, the value i increases or decreases when a data symbol is stored to the memory;
a cyclic cell counter generating counter value j, wherein the value j ranges from 0 to M−1, increases or decreases when i returns to an initial value of i;
N cyclic segment counters respectively generating counter values C₀, . . . , C_{N-1}, wherein Cᵢ corresponds to branch i, ranges from 0 to Uᵢ-1, increases or decreases when j returns to an initial value of j; and
a processor generating the address for reading/storing the memory at least according to the value N, the value i, the value j, and the value Cᵢ;
wherein N is a number of branches of the interleaver/de-interleaver, M is a number of cells of one segment, Uᵢ is a non-negative integer representing number of segments of branch i.

2. The address generator as claimed in claim 1, wherein one of the cyclic branch counter and the cyclic cell counter and the N cyclic segment counters is a cyclic counter which ranges from a minimum value to a maximum value, starts counting at the minimum value, increases till reaching the maximum value, then returns to the minimum value to continue increasing again.

3. The address generator as claimed in claim 1, wherein one of the cyclic branch counter and the cyclic cell counter and the N cyclic segment counters is cyclic counter which ranges from a minimum value to a maximum value, starts counting at the maximum value, decreases till reaching the minimum value, then returns to the maximum value to continue decreasing again.

4. The address generator as claimed in claim 1, wherein Uᵢ equals to i.

5. The address generator as claimed claim 4, wherein the processor generates the address for reading/storing a data symbol from/to the memory according to a formula:
$$( {\sum }_{n = 0}^{i - 1} {U}_{n} + {C}_{i} ) + j * {\sum }_{n = 0}^{N - 1} {U}_{n} .$$

6. The address generator as claimed in claim 4, wherein the processor generates the addresses for reading/storing a data symbol from/to the memory according to a formula:
$$M * ( {\sum }_{n = 0}^{i - 1} {U}_{n} + {C}_{i} ) + j$$

7. The address generator as claim 4, wherein the processor generates the address for reading/storing a data symbol from/to the memory according to a formula:
$$( {\sum }_{n = i - 1}^{N - 1} {U}_{n} + {C}_{i} ) + j * {\sum }_{n = 0}^{N - 1} {U}_{n} .$$

8. The address generator as claimed in claim 4, wherein the processor generates the addresses for reading/storing a data symbol from/to the memory according to a formula:
$$( {C}_{i} + {\sum }_{n = i - 1}^{N - 1} {U}_{n } ) \cdot M + j .$$

9. A (N,M) convolutional interleaver/de-interleaver comprising:
an input port receiving an input data symbol;
a storage device having an address input, a data input and a data output;
an address generator generating an address for reading/storing a data symbol from/to the storage device, comprising:
a cyclic branch counter generating counter value i, wherein the value i ranges from 0 to N−1 respectively indicating branch 0 to branch N−1, the value i increases or decreases when a data symbol is stored to the storage device;
a cyclic cell counter generating counter value j, wherein the value i ranges from 0 to M−1, increases or decreases when i returns to an initial value of i;
N cyclic segment counters respectively generating counter values C₀, . . . , C_{N-1}, wherein Cᵢ corresponds to branch i, ranges from 0 to Uᵢ-1, increases or decreases when j returns to an initial value of j; and
a processor generating the address for accessing the storage device at least according to the value N. the value i, the value j, and the value Cᵢ; and
an output port for outputting symbols corresponding to the address;
wherein N is a number of branches of the interleaver/de-interleaver, M is a number of cells of one segment, Uᵢ is a non-negative integer representing number of segments of branch i.

10. The convolutional interleaver/deinterleaver as claimed in claim 9, further comprising a memory interface coupled to the input port and the output port, wherein the memory interface delivers the address generated by the address generator to the address input of the storage device, delivers a symbol read from the storage device to the output port and delivers the input data symbol to the data input of the storage device.

11. The convolutional interleaver/deinterleaver as claimed in claim 9, further comprising a memory interface coupled to the input port and the output port, while the value i indicating a branch i with Uᵢ=0 the memory interface bypasses the input data symbol to the output port.

12. The convolutional interleaver/deinterleaver as claimed in claim 9, further comprising a storage device for programming a value of M.

13. The convolutional interleaver/deinterleaver as claimed in claim 9, further comprising a storage device for programming a value of N.

14. The convolutional interleaver/deinterleaver as claim 9, wherein the data symbol is a K-bit symbol with K being an integer.

15. The convolutional interleaver/deinterleaver as claimed in claim 9, wherein the data symbol is a 1-bit symbol.

16. The address generator as claimed in claim 9, wherein Uᵢ equals to i.

17. The convolutional interleaver/deinterleaver as claim 16, wherein the processor generates the address for reading/storing a data symbol from/to the storage device according to a formula:
$${M}^{*} ( {\sum }_{n = 0}^{i - 1} {U}_{n} + Ci ) + j .$$

18. The convolutional interleaver/deinterleaver as claim 16, wherein the processor generates the address for reading/storing a data symbol from/to the storage device according to a formula:
$$( {\sum }_{n = 0}^{i - 1} {U}_{n} + Ci ) + {j}^{*} {\sum }_{n = 0}^{N - 1} {U}_{n} .$$

19. The convolutional interleaver/deinterleaver as claim 16, and the processor generates the address for reading/storing a data symbol from/to the storage device according to a formula:
$${\sum {U}_{n}}_{{M}^{*} ( n = i - 1 + Ci ) + j .}^{N - 1}$$

20. The address generator as claimed in claim 16, wherein the processor generates the address for reading/storing a data symbol from/to the storage device according to a formula:
$${\sum {U}_{n}}_{( n = i - 1 + Ci ) + {j}^{*}}^{N - 1} {\sum }_{n = 0}^{N - 1} {U}_{n}$$
